(19) United States
(12) Patent Application Publication
(10) Pub. No.: US 2025/0337556 A1
(43) Pub. Date: Oct. 30, 2025

(54) MAINTAINING TIMING SYNCHRONIZATION IN NETWORK DEVICES

(71) Applicant: Cisco Technology, Inc., San Jose, CA (US)

(72) Inventors: Jiayou Meng, Shanghai (CN); Tianming Wang, Shanghai (CN); Liwei Guo, Shanghai (CN)

(21) Appl. No.: 18/646,573

(22) Filed: Apr. 25, 2024

(51) Int. Cl. H04L 7/00

(52) U.S. Cl. CPC H04L 7/0037

(57) ABSTRACT

Devices, systems, methods, and processes for synchronizing communication ports in a network device using phase-aligned output synchronization signals are described herein. The network device may utilize the communication ports to exchange timestamped messages with other network devices for precise time coordination. Therefore, a timing error in the communication ports (e.g., differences in local times of the communication ports) may affect the precise time coordination accuracy of the network device. Thus, the communication ports are pre-emptively time synchronized using the phase-aligned output synchronization signals to improve the precise time coordination accuracy. The phase-aligned output synchronization signals may be generated by applying individual phase adjustments to an input synchronization signal for each communication port. The application of the individual phase adjustments to the input synchronization signal compensates for delay skews associated with the communication ports. Thus, the communication ports may receive the output synchronization signals in a phase aligned manner.

The present disclosure relates to wireless networks. More particularly, the present disclosure relates to synchronizing communication ports in a network device using phase-aligned synchronization signals.

### BACKGROUND

In today's interconnected world, wireless networks have become indispensable in facilitating seamless communication. From enabling mobile connectivity to supporting the Internet of Things (IoT) and powering critical infrastructure, wireless networks provide flexibility, scalability, and accessibility.

However, wireless networks often experience variable delays due to a multitude of factors, for example, signal attenuation, multipath interference, and unpredictable channel conditions. These delays can result in significant timing discrepancies among devices, undermining the reliability and performance of critical applications that depend on synchronized timing for seamless operation.

To address such timing discrepancies in wireless networks, various precise time synchronization protocols (for example, Precision Time Protocol and Network Time Protocol) have been developed. Besides application-specific demands, regulatory requirements and industry standards also mandate the use of such precise time synchronization protocols for maintaining stringent timing accuracy in wireless networks. Typically, these precise time synchronization protocols rely on accurate timestamping, and any deviation in these timestamps can introduce synchronization errors, leading to degraded performance.

### SUMMARY OF THE DISCLOSURE

Systems and methods for synchronizing communication ports in a network device using phase-aligned synchronization signals in accordance with embodiments of the disclosure are described herein. In some embodiments, a device includes a plurality of components, a processor, a network interface controller configured to provide access to a network, and a memory communicatively coupled to the processor, wherein the memory includes a phase adjusting logic that is configured to receive an input synchronization signal, generate a plurality of output synchronization signals by applying a plurality of phase adjustments to the input synchronization signal, and provide a corresponding output synchronization signal of the plurality of output synchronization signals to each of the plurality of components.

In some embodiments, the input synchronization signal is a pulse-per-second signal.

In some embodiments, each of the plurality of output synchronization signals is associated with a different phase adjustment of the plurality of phase adjustments.

In some embodiments, to generate the plurality of output synchronization signals, the phase adjusting logic is further configured to receive an input setting indicative of a delay associated with each of the plurality of components, determine a delay skew associated with each component of the plurality of components based on the input setting, and configure the plurality of phase adjustments based on the delay skew associated with each component of the plurality of components, wherein the plurality of output synchronization signals are generated in response to the configuration of the plurality of phase adjustments.

In some embodiments, the delay includes at least one of a trace propagation delay, a package delay, a buffer delay, or a flip-flop delay.

In some embodiments, the plurality of phase adjustments are reconfigurable to accommodate one or more delay changes associated with one or more of the plurality of components.

In some embodiments, the memory further includes a reference timer configured to provide a reference time.

In some embodiments, at least one of the plurality of components is configured to synchronize with the reference timer based on the corresponding output synchronization signal.

In some embodiments, the plurality of output synchronization signals are phase aligned with each other.

In some embodiments, the plurality of output synchronization signals are phase aligned with each other with a margin of error of less than or equal to a preset value.

In some embodiments, the preset value corresponds to a maximum timing error associated with one or more functional applications of the device.

In some embodiments, the plurality of components include at least one communication port.

In some embodiments, a phase adjusting logic is configured to receive an input clock signal and an input synchronization signal, modify the input clock signal based on a delay skew associated with each of the plurality of components to obtain a plurality of output clock signals, generate a plurality of output synchronization signals based on the input synchronization signal and the plurality of output clock signals, and provide the plurality of output synchronization signals to the plurality of components.

In some embodiments, the plurality of output clock signals are associated with a plurality of phase adjustments.

In some embodiments, to generate the plurality of output synchronization signals, the phase adjusting logic is further configured to apply the plurality of phase adjustments associated with the plurality of output clock signals to the input synchronization signal.

In some embodiments, each of the plurality of output synchronization signals is a mirror of the input synchronization signal with a phase shift associated with an output clock signal of the plurality of output clock signals.

In some embodiments, a device includes one of a phase locked loop (PLL) or a mixed-mode clock manager (MMCM), and a plurality of buffers coupled to the one of the phase locked loop (PLL) or the mixed-mode clock manager (MMCM).

In some embodiments, the phase adjusting logic is implemented based on the plurality of buffers and one of the PLL or the MMCM.

In some embodiments, time synchronization includes receiving an input synchronization signal, generating a plurality of output synchronization signals by applying a plurality of phase adjustments on the input synchronization signal, and synchronizing a plurality of components in a device with a reference timer based on the plurality of output synchronization signals.

In some embodiments, time synchronization further includes reconfiguring one or more of the plurality of phase adjustments based one or more delay changes associated with one or more of the plurality of components.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments that a networking logic may operate on a plurality of network devices, in accordance with various embodiments of the disclosure;

FIG. 2 is a conceptual block diagram illustrating time synchronization between two network devices in accordance with various embodiments of the disclosure;

FIG. 3A is a conceptual diagram illustrating a network device that is capable of performing time synchronization using phase-aligned synchronization signals in accordance with various embodiments of the disclosure;

FIG. 3B is a conceptual diagram illustrating phase-aligned synchronization signals in accordance with various embodiments of the disclosure;

FIG. 4 is a flowchart showing a process for time synchronization between a first network device and a second network device in accordance with various embodiments of the disclosure;

FIG. 5 is a flowchart showing a process for synchronizing components of a network device using phase-aligned synchronization signals in accordance with various embodiments of the disclosure;

FIG. 6 is a flowchart showing a process for synchronizing components of a network device using phase-aligned synchronization signals in accordance with various embodiments of the disclosure; and

FIG. 7 is a conceptual block diagram for one or more devices capable of executing components and logic for implementing the functionality and embodiments described above.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that utilize phase-aligned synchronization signals (e.g., pulse-per-second signals that are phase-aligned) to synchronize communication ports in a network device. Generally, wireless networks use precise time synchronization protocols (e.g., Precision Time Protocol) to maintain stringent timing accuracy among wireless devices. These precise time synchronization protocols often rely on accurate timestamping, and any deviation in these timestamps can introduce synchronization errors. Timing misalignment among communication ports of a network device is a significant factor contributing to the degradation of accuracy in precise time synchronization protocols. Therefore, there is a need for an efficient solution that accurately synchronizes various communication ports of a network device with a reference timer (e.g., a system clock) of the network device.

In many embodiments, a device (e.g., a network device) may include a plurality of communication ports that need to be synchronized with a reference timer. For synchronizing the plurality of communication ports, an input synchronization signal (for example, a pulse-per-second signal) is often provided to the plurality of communication ports. However, in some embodiments, the plurality of communication ports may be associated with varying delays, for example, varying external and internal delays. Various delay factors may include, but are not limited to, a trace propagation delay, a package delay, a buffer delay, or a flip-flop delay. As a result, if the same input synchronization signal is provided to the plurality of communication ports, the input synchronization signal may experience a different delay while propagating to each communication port, leading to synchronization error.

In a number of embodiments, the device may include a programmable logic (for example, an Input/Output Field Programmable Array) that may apply an individual phase adjustment to the input synchronization signal for each communication port. These individual phase adjustments (e.g., a plurality of phase adjustments) when applied to the input synchronization signal may generate a plurality of output synchronization signals, for example, one output synchronization signal for each communication port. Each output synchronization signal may be a mirror of the input synchronization signal with a different phase shift, for example, as defined by each phase adjustment.

In a variety of embodiments, the plurality of phase adjustments may be configured based on the delay (for example, the external delay or the internal delay) associated with each communication port. For example, the plurality of phase adjustments may be configured to compensate for delay skews among the plurality of communication ports. Delay skew may refer to a difference in the delay of a communication port from a reference delay value. Based on the compensation of the delay skews, the plurality of communication ports may receive phase-aligned output synchronization signals.

In more embodiments, the programmable logic may apply the plurality of phase adjustments to the input synchronization signal by utilizing a plurality of output clock signals. For example, each output clock signal may be associated with a different phase adjustment which is applied to the input synchronization signal, resulting in the generation of the plurality of output synchronization signals. The plurality of output clock signals may be obtained (or generated) by modifying an input clock signal based on an individual delay skew associated with each of the plurality of components. In other words, the input clock signal is phase shifted according to the delay skew associated with each component, and a corresponding output clock signal is obtained. Further, each output synchronization signal may be a mirror of the input synchronization signal with a phase shift associated with a corresponding output clock signal.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

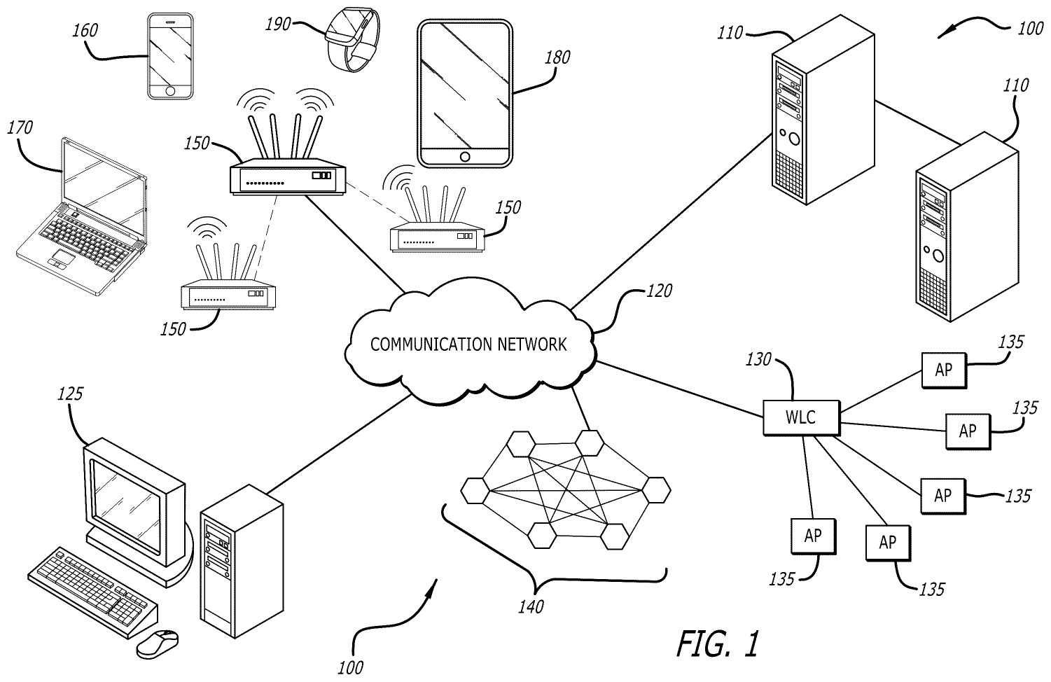

Referring to FIG. 1, a conceptual network diagram 100 of various environments that a networking logic may operate on a plurality of network devices in accordance with various embodiments of the disclosure is shown. Those skilled in the art will recognize that the networking logic can include various hardware and/or software deployments and can be configured in a variety of ways. In many embodiments, the networking logic can be configured as a standalone device, exist as a logic in another network device, be distributed among various network devices operating in tandem, or remotely operated as part of a cloud-based network management tool. In further embodiments, one or more servers 110 can be configured with the networking logic or can otherwise operate as the networking logic. In many embodiments, the networking logic may operate on one or more servers 110 connected to a communication network 120 (shown as the “Internet”). The communication network 120 can include wired networks or wireless networks. The networking logic can be provided as a cloud-based service that can service remote networks, such as, but not limited to a deployed network 140.

However, in additional embodiments, the networking logic may be operated as a distributed logic across multiple network devices. In the embodiment depicted in FIG. 1, a plurality of network access points (APs) 150 can operate as the networking logic in a distributed manner or may have one specific device operate as the networking logic for all of the neighboring or sibling APs 150. The APs 150 may facilitate Wi-Fi connections for various electronic devices, such as but not limited to, mobile computing devices including laptop computers 170, cellular phones 160, portable tablet computers 180 and wearable computing devices 190.

In further embodiments, the networking logic may be integrated within another network device. In the embodiment depicted in FIG. 1, a wireless LAN controller (WLC) 130 may have an integrated networking logic that the WLC 130 can use to monitor or control power consumption of the APs 135 that the WLC 130 is connected to, either wired or wirelessly. In still more embodiments, a personal computer 125 may be utilized to access and/or manage various aspects of the networking logic, either remotely or within the network itself. In the embodiment depicted in FIG. 1, the personal computer 125 communicates over the communication network 120 and can access the networking logic of the servers 110, or the network APs 150, or the WLC 130.

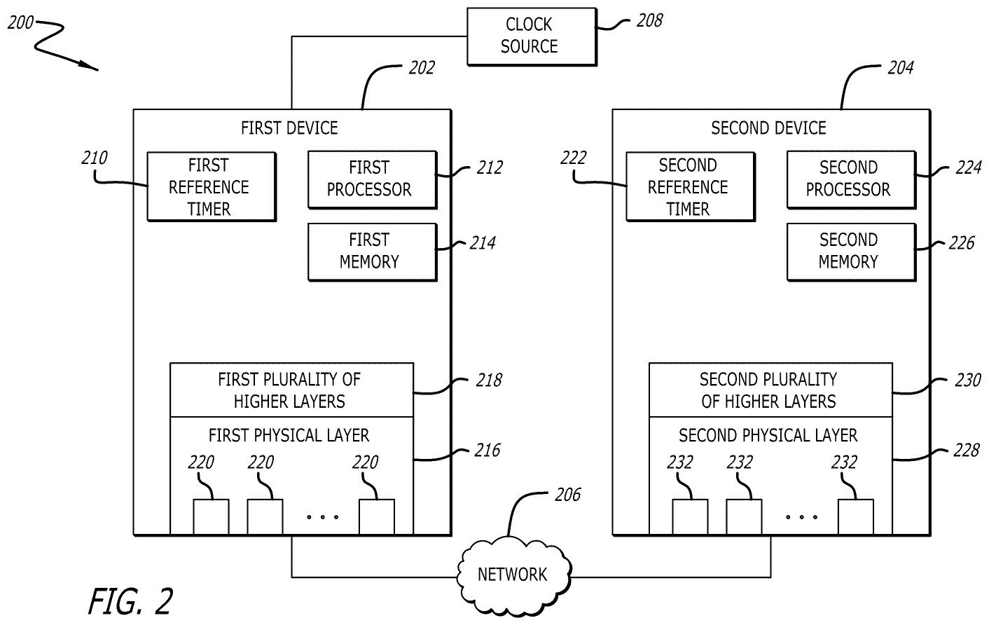

Although a specific embodiment for various environments that the networking logic may operate on a plurality of network devices suitable for carrying out the various steps, processes, methods, and operations described herein is discussed with respect to FIG. 1, any of a variety of systems and/or processes may be utilized in accordance with embodiments of the disclosure. In many non-limiting examples, the networking logic may be provided as a device or software separate from the WLC 130 or the networking logic may be integrated into the WLC 130. The elements depicted in FIG. 1 may also be interchangeable with other elements of FIGS. 2-7 and as required to realize a particularly desired embodiment.

Referring to FIG. 2, a conceptual block diagram 200 illustrating time synchronization between two network devices in accordance with various embodiments of the disclosure is shown. The embodiments depicted in the conceptual diagram 200 may show a scenario where a first device 202 is communicatively coupled to a second device 204 via a communication network 206, and a clock source 208. The clock source 208 may generate a “true” time or an accepted standard of true time. Examples of the clock source 208 can include, but are not limited to, a global positioning system (GPS) module, a crystal oscillator, or the like.

In many embodiments, the first device 202 may include a first reference timer 210, a first processor 212, and a first memory 214. The first device 202 may further include a first network protocol stack including a first physical layer 216 and a first plurality of higher layers 218, for example, a media access control (MAC) layer, a network layer, a transport layer, a session layer, a presentation layer, an application layer, and/or one or more other layers defined in, for example, the Open Systems Interconnection (OSI) model. The first device 202 may further include a first plurality of communication ports 220. In a number of embodiments, the first plurality of communication ports 220 may be associated with the first physical layer 216. In a variety of embodiments, the first plurality of communication ports 220 can be associated with any of the first plurality of higher layers 218. In numerous embodiments, the first processor 212 may be configured to execute one or more instructions stored in the first memory 214 for performing one or more time/clock synchronization operations, for example, maintaining synchronization of the first reference timer 210 with one or more other clocks, for example, the clock source 208. In an example, the first reference timer 210 can be a time-of-day (ToD) counter.

Likewise, the second device 204 may also include a second reference timer 222, a second processor 224, and a second memory 226. The second device 204 may further include a second network protocol stack including a second physical layer 228 and a second plurality of higher layers 230, and a second plurality of communication ports 232. In some embodiments, the second processor 224 may be configured to execute one or more instructions stored in the second memory 226 for performing one or more time/clock synchronization operations, for example, maintaining synchronization of the second reference timer 222 with one or more other clocks, for example, the first reference timer 210. In an example, the second reference timer 222 can be a ToD counter.

In more embodiments, the first device 202 and the second device 204 may be configured to conform to a precision time synchronization protocol (e.g., Precision Time Protocol as defined in the IEEE 1588 protocol) to precisely coordinate time with each other. Various timestamped messages may be exchanged between the first device 202 and the second device 204, allowing the second device 204 to synchronize the second reference timer 222 with the first reference timer 210. In additional embodiments, the timestamped messages may be exchanged between the first device 202 and the second device 204 using the first plurality of communication ports 220 and the second plurality of communication ports 232. In further embodiments, instead of relying on a single communication port for entire message exchange, the first device 202 and/or the second device 204 may use different communication ports for exchanging different messages.

In still more embodiments, a communication port (for example, any of the first plurality of communication ports 220 or any of the second plurality of communication ports 232) can maintain a local timer (e.g., a ToD counter) to assign a timestamp to synchronization messages. Thus, in embodiments, where the first plurality of communication ports 220 and the second plurality of communication ports 232 maintain respective local timers, it may be required to pre-emptively synchronize the local timers with respective system clocks/timers to avoid any errors in timing synchronization between the first device 202 and the second device 204. For example, the local timers of the first plurality of communication ports 220 may be required to be synchronized with the first reference timer 210 and the local timers of the second plurality of communication ports 232 may be required to be synchronized with the second reference timer 222.

In still further embodiments, an input synchronization signal may be utilized to synchronize the local timers of the first plurality of communication ports 220 with the first reference timer 210. For example, the input synchronization signal can be a pulse-per-second signal. A “pulse-per-second” (PPS) signal can be a periodic signal that produces one pulse every second. The PPS signal may serve as a reference point for accurately synchronizing the operations of various components, e.g., the local timers of the first plurality of communication ports 220. Similarly, the second device 204 may also utilize another input synchronization signal to synchronize the local timers of the second plurality of communication ports 232 with the second reference timer 222.

In still additional embodiments, the first plurality of communication ports 220 may exhibit different delays, for example, due to difference in a trace propagation delay, a package delay, a buffer delay, a flip-flop delay, or the like. Therefore, if the same input synchronization signal is provided to the first plurality of communication ports 220, the input synchronization signal may experience a different delay while propagating to each of the first plurality of communication ports 220, leading to inaccurate synchronization of the first plurality of communication ports 220 with the first reference timer 210.

Thus, in certain embodiments, an individual phase adjustment may be applied to the input synchronization signal for each of the first plurality of communication ports 220 to generate a plurality of output synchronization signals, for example, one output synchronization signal for each communication port. In other words, each output synchronization signal may be associated with a different phase adjustment. By applying the individual phase adjustment to the input synchronization signal for each of the first plurality of communication ports 220, the difference in the delays of the first plurality of communication ports 220 may be compensated. As a result, the first plurality of communication ports 220 may receive the plurality of output synchronization signals which are phase aligned with each other. The local timers of the second plurality of communication ports 232 can also be synchronized with the second reference timer 222 by utilizing phase-aligned output synchronization signals. Thus, improving an overall synchronization accuracy of the precision time synchronization protocol, for example, the Precision Time Protocol (PTP) IEEE 1588 protocol.

Although a specific embodiment for time synchronization between two network devices suitable for carrying out the various steps, processes, methods, and operations described herein is discussed with respect to FIG. 2, any of a variety of systems and/or processes may be utilized in accordance with embodiments of the disclosure. For example, a network device (e.g., the first device 202 or the second device 204) may utilize phase-aligned output synchronization signals to synchronize various other components (e.g., antenna arrays, sensors, radio frequency components, power management components, or the like) as well with a reference timer. The elements depicted in FIG. 2 may also be interchangeable with other elements of FIGS. 1 and 3A-7 as required to realize a particularly desired embodiment.

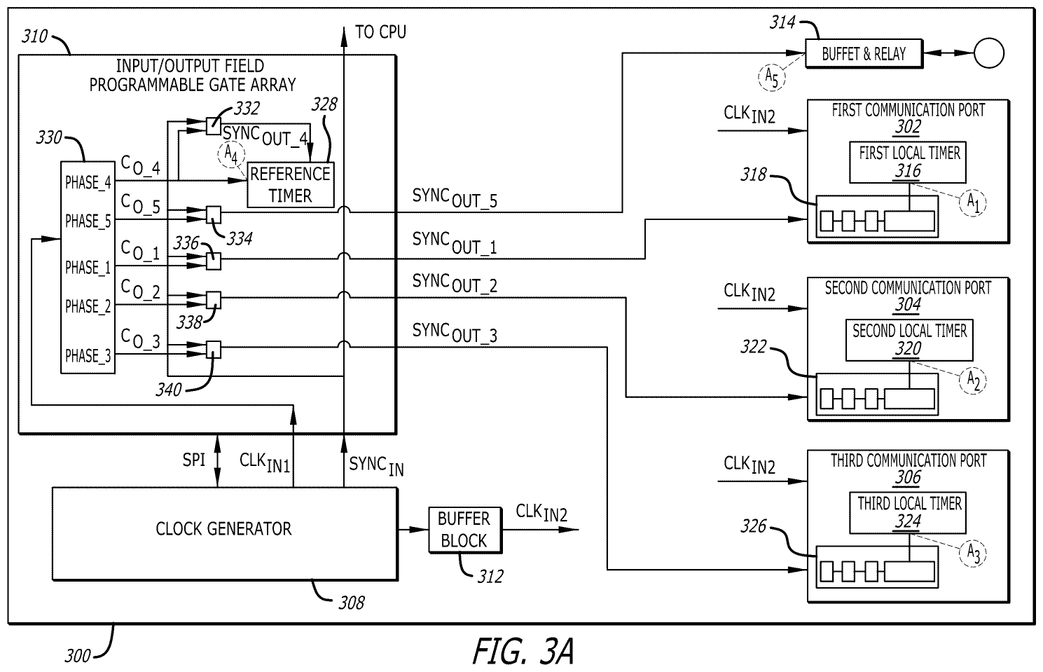

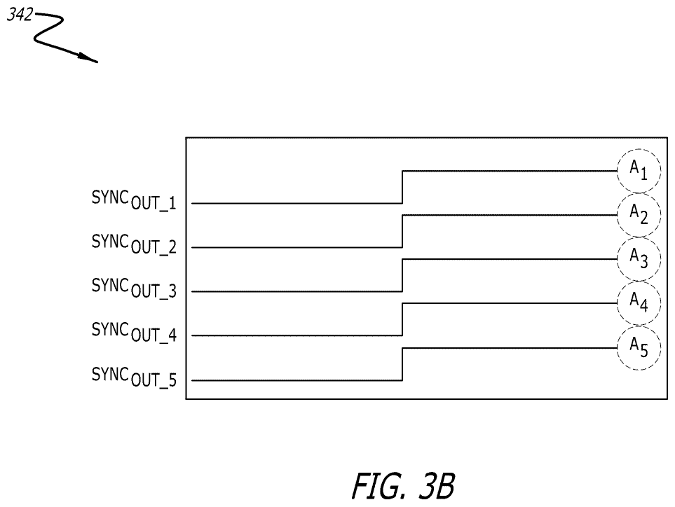

Referring to FIG. 3A, a conceptual block diagram illustrating a network device 300 that is capable of performing time synchronization using phase-aligned synchronization signals in accordance with various embodiments of the disclosure is shown. Embodiments of the conceptual diagram depicted in FIG. 3A may show a scenario where the network device 300 may be configured to improve an overall synchronization accuracy of a precision time synchronization protocol (e.g., a PTP IEEE 1588 protocol) by synchronizing its various components.

In many embodiments, the network device 300 may include a plurality of components (e.g., internal components) that need to be synchronized. Examples of the plurality of components may include a plurality of communication ports (such as a first communication port 302, a second communication port 304, a third communication port 306) and many other components (such as antenna arrays, sensors, radio frequency components, power management components, or the like) which require time synchronization. In a number of embodiments, the network device 300 may further include a clock generator 308 that may generate an input clock signal Clk_{In1} and an input synchronization signal Sync_{IN} for time synchronization. The clock generator 308 may further generate another clock signal Clk_{IN2} for the plurality of components. Examples of the clock generator 308 may include, but are not limited to, a digital phase locked loop, voltage controller oscillator, etc.

In a variety of embodiments, the network device 300 may further include a programmable logic device (for example, an Input/Output Field Programmable Gate Array (IOFPGA) 310) which receives and utilizes the input clock signal Clk_{IN11} and the input synchronization signal Sync_{IN} to synchronize the plurality of components with a reference timer 328. In an example, the reference timer 328 may be a time-of-day (ToD) counter that provides a reference time for the network device 300. In some embodiments, the reference timer 328 can be maintained within the IOFPGA 310. The network device 300 may further include a buffer block 312 that receives the clock signal Clk_{IN2} from the clock generator 308 and provides the clock signal CIK_{IN2} to the plurality of components for their operations, and a buffer relay block 314 utilized for diagnostic and error detection purposes. For example, an output of the buffer relay block 314 may be coupled to a testing port for diagnostic and error detection purposes.

In more embodiments, each of the plurality of components may include a local timer (e.g., a local ToD counter), which needs to be synchronized with the reference timer 328, and internal circuitry such as digital signal filters, flip-flops, buffers, interfaces, or the like. The embodiments of the network device 300 may show a scenario where the first communication port 302 includes a first local timer 316 and first internal circuitry 318, the second communication port 304 includes a second local timer 320 and second internal circuitry 322, and the third communication port 306 includes a third local timer 324 and third internal circuitry 326.

The plurality of components can be positioned at different locations within the network device 300 and may feature variable internal circuitry. Such variability in locations and internal circuitry may introduce diverse external and internal delays affecting the propagation of signals to these plurality of components. As a result, a same signal may reach the local timers of the plurality of components at different times. In order to improve the accuracy of synchronization, the IOFPGA 310 may ensure that synchronization signals reach the local timers of the plurality of components in a phase aligned manner, eliminating any deviation in the times of the local timers.

In additional embodiments, the IOFPGA 310 may be communicatively coupled to the clock generator 308, for example, via a serial peripheral interface. The IOFPGA 310 may receive the input clock signal Clk_{IN1} and the input synchronization signal Sync_{IN} from the clock generator 308. The input synchronization signal Sync_{IN} may be further provided to a central processor (e.g., a central processing unit, CPU) of the device 300. The IOFPGA 310 may include a phase adjusting logic implemented by a clock modifying circuitry 330 and a plurality of buffers 332-340. Examples of the clock modifying circuitry 330 may include, but are not limited to, a phase locked loop (PLL) or a mixed-mode clock manager (MMCM). The input clock signal Clk_{IN1} may be provided to the clock modifying circuitry 330 as input and the input synchronization signal Sync_{IN} may be provided as input to each of the plurality of buffers 332-340.

In further embodiments, the IOFPGA 310 may receive information pertaining to a delay associated with each of the plurality of components. In further additional embodiments, the IOFPGA 310 may receive an input setting indicating the delay associated with each of the plurality of components. For example, the input setting may indicate that the first communication port 302 is associated with a delay of ‘X1’ seconds, the second communication port 304 is associated with a delay of ‘X2’ seconds, and the third communication port 306 is associated with a delay of ‘X3’ seconds. In still yet further embodiments, the network device 300 may include a dedicated circuitry configured to determine the information pertaining to a delay experienced by a test signal propagating from the IOFPGA 310 to individual local timers of each component and provide the information to the IOFPGA 310.

In still more embodiments, the IOFPGA 310 may determine a delay skew associated with each component based on the received information (for example, the input setting). To determine the delay skew associated with each component, the IOFPGA 310 may select a reference and determine a skew of each delay (e.g., delay value) from the reference. For example, the IOFPGA 310 may select the highest delay value as reference and determine a skew of each delay value from the reference. Thus, if ‘X3’ seconds is selected as the reference, the delay skew associated with the first communication port 302 may be (X3-X1) seconds, the delay skew associated with the second communication port 304 may be (X3-X2) seconds, and the delay skew associated with the third communication port 306 may be (X3-X3) seconds. In more examples, the IOFPGA 310 may select the lowest delay value as reference and a skew of each delay value from the reference is determined. In yet more examples, the IOFPGA 310 may select any delay value as reference and a skew of each delay value from the reference is determined. In numerous examples, the IOFPGA 310 may select a delay value associated with the reference timer 328 as the reference and a skew of each delay value from the reference is determined. In other words, the IOFPGA 310 may determine a difference of each delay value from the selected reference.

In still further embodiments, the IOFPGA 310 may configure a plurality of phase adjustments based on the delay skew associated with each of the plurality of components. In other words, the IOFPGA 310 may determine how much individual phase shift (e.g., by advancing or by delaying) shall be applied to a signal for each component such that the signal reaches the local timers of the plurality of components in a phase aligned manner. The value of the individual phase shift may be represented as a phase adjustment. In still additional embodiments, the plurality of phase adjustments may be reconfigurable. For example, the IOFPGA 310 may accommodate delay changes associated with one or more of the plurality of components by reconfiguring corresponding phase adjustments. The delay changes can occur due to component aging, component replacement, or the like. The clock modifying circuitry 330 may be configured with the plurality of phase adjustments.

In numerous additional embodiments, the clock modifying circuitry 330 may receive the input clock signal Clk_{IN}, modify the input clock signal Clk_{IN} based on the delay skew associated with each of the plurality of components, and obtain a plurality of output clock signals Clk_{OUT_1}-Clk_{OUT_5}. For example, to modify the input clock signal Clk_{IN}, the phase shift indicated by each phase adjustment is applied to the input clock signal Clk_{IN} and an individual output clock signal CIK_{OUT_1}-CIK_{OUT_5} is obtained for each phase adjustment. In other words, each output clock signal Clk_{OUT_1}-Clk_{OUT_5} is associated with a different phase adjustment and corresponds to a different component of the plurality of components. For example, a first output clock signal Clk_{OUT_1} obtained based on a first phase adjustment phase_1 may correspond to the first communication port 302. Similarly, a second output clock signal Clk_{OUT_2} can be obtained based on a second phase adjustment phase_2 for the second communication port 304 and a third output clock signal Clk_{OUT_3} can be obtained based on a third phase adjustment phase_3 for the third communication port 306. In some more embodiments, the clock modifying circuitry 330 may generate additional output clock signals Clk_{OUT_4} and Clk_{OUT_5}, for example, for the reference timer 328, for the buffer relay block 314, and for other components.

In certain embodiments, the clock modifying circuitry 330 may be communicatively coupled to the plurality of buffers 332-340 and may provide the plurality of output clock signals CIK_{OUT_1}-CIK_{OUT_5} to the plurality of buffers 332-340, for example, one output clock signal to each of the plurality of buffers 332-340. In several embodiments, the reference timer 328 may further receive the output clock signal Clk_{OUT_4} for synchronization. Each of the plurality of buffers 332-340 may additionally receive the input synchronization signal Sync_{IN}. The plurality of buffers 332-340 may generate a plurality of output synchronization signals Sync_{OUT_1}-Sync_{OUT_5} based on the input synchronization signal Sync_{IN} and the plurality of output clock signals Clk_{OUT_1}-Clk_{OUT_5}. For example, at each buffer, the phase adjustment associated with a corresponding received output clock signal may be applied to the input synchronization signal Sync_{IN} and an output synchronization signal may be generated. The generated output synchronization signal may be a mirror of the input synchronization signal Sync_{IN} with a phase shift of the corresponding output clock signal. In other words, the plurality of buffers 332-340 may generate the plurality of output synchronization signals Sync_{OUT_1}-Sync_{OUT_5}, where each output synchronization signal is configured to compensate the delay skew associated with a specific component.

In yet more embodiments, the plurality of output synchronization signals Sync_{OUT_1}-Sync_{OUT_5} are provided to corresponding plurality of components. For example, as depicted in the embodiment of FIG. 3A, the first communication port 302, the second communication port 304, the third communication port 306, the reference timer 328, and the buffer relay block 314 receive the respective plurality of output synchronization signals Sync_{OUT_1}-Sync_{OUT_5}, for example, one output synchronization signal each. The plurality of output synchronization signals Sync_{OUT_1}-Sync_{OUT_5} are phase aligned with each other. For example, the plurality of output synchronization signals Sync_{OUT_1}-Sync_{OUT_5} when received at respective locations A1, A2, A3, A4, and A5 are phase aligned with each other. The location A1 may correspond to an input of the first local timer 316, the location A2 may correspond to an input of the second local timer 320, the location A3 may correspond to an input of the third local timer 324, the location A4 may correspond to an input of the reference timer 328, and the location A5 may correspond to an input of the buffer relay block 314. In still yet more embodiments, the plurality of components upon receiving the plurality of output synchronization signals Sync_{OUT_1}-Sync_{OUT_5} may synchronize with the reference timer 328.

Referring to FIG. 3B, a conceptual diagram 342 illustrating phase-aligned synchronization signals in accordance with various embodiments of the disclosure is shown. Embodiments of the conceptual diagram 342 may show a scenario where the plurality of output synchronization signals Sync_{OUT_1}-Sync_{OUT_5} received by the plurality of components of the network device 300 (depicted in FIG. 3A) are phase aligned with each other.

In many embodiments, the plurality of output synchronization signals Sync_{OUT_1}-Sync_{OUT_5} may be phase aligned with each other with a margin of error of less than or equal to a preset value. In some embodiments, the preset value may correspond to a maximum timing error associated with one or more functional applications of the network device 300. For example, the preset value may be less than or equal to 125 picoseconds (ps). In other words, a phase adjustment accuracy of +/−125 ps can be achieved among the plurality of output synchronization signals Sync_{OUT_1}-Sync_{OUT_5} received at the respective locations A1, A2, A3, A4, and A5 of the network device 300. Such phase adjustment accuracy may further improve accuracy of a precision time synchronization protocol utilized by the network device 300.

Although a specific embodiment for time synchronization using phase-aligned output synchronization signals suitable for carrying out the various steps, processes, methods, and operations described herein is discussed with respect to FIGS. 3A and 3B, any of a variety of systems and/or processes may be utilized in accordance with embodiments of the disclosure. For example, the network device 300 can generate as many output synchronization signals as required and a count of the plurality of output synchronization signals may not be limited to 5 as depicted in the embodiments of FIGS. 3A and 3B. The elements depicted in FIG. 2 may also be interchangeable with other elements of FIGS. 1, 2 and 4-7 as required to realize a particularly desired embodiment.

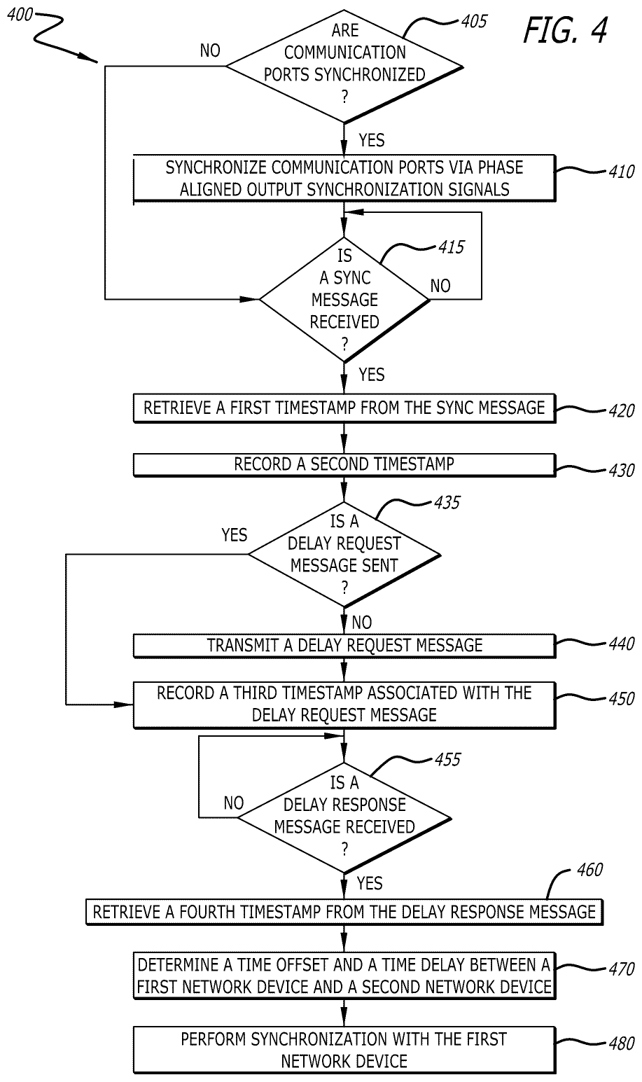

Referring to FIG. 4, a flowchart showing a process 400 for time synchronization between a first network device and a second network device in accordance with various embodiments of the disclosure is shown. In numerous embodiments, the process 400 may determine if communication ports of the second network device are synchronized (block 405). The communication ports may need to synchronize with a reference timer of the second network device to prevent errors in the time synchronization of the second network device with the first network device.

When the communication ports are not synchronized, various embodiments of the process 400 may synchronize the communication ports via phase-aligned output synchronization signals (410). In numerous additional embodiments, the phase-aligned output synchronization signals may be phase shifted pulse-per-second signals. The pulse-per-second signal may be phase shifted in accordance with individual delays associated with each communication port to generate the output synchronization signals.

However, when the communication ports are synchronized, various embodiments of the process 400 may determine if a sync message is received (block 415). The sync message may include a message type identifier, a sequence identifier to track message order, and a timestamp indicating the time when the sync message was sent by the first network device. The message type identifier may be utilized to distinguish the sync message from other messages. When the sync message is not received, various embodiments of the process 400 may continue to wait to receive the sync message (block 415).

However, when the sync message is received, the process 400 can retrieve a first timestamp from the sync message (block 420). The first timestamp may indicate the time when the sync message was sent by the first network device. As those skilled in the art will recognize, reception of one sync message is shown for illustrative purposes. In a number of embodiments, a second network device may receive multiple sync messages from the first network device based on a periodic rate requested by the second network device. In certain embodiments, the first timestamp may be appended with the sync message based on a local time maintained by a communication port of the first network device that transmitted the sync message.

In a variety of embodiments, the process 400 may record a second timestamp (block 430). The second timestamp may indicate a time of arrival of the sync message at the second network device. In some embodiments, the second timestamp may be recorded based on a local time maintained by a communication port of the second network device that received the sync message.

In some embodiments, the process 400 may determine if a delay request message is transmitted (block 435). The delay request message may be transmitted to determine a propagation delay between the first network device and the second network device. The delay request message may include a message type identifier, a sequence identifier to track message order, a timestamp indicating the time when the delay request message is transmitted by the second network device, a source identifier, or the like. The source identifier may enable the first network device to identify the requesting device, e.g., the second network device. When the delay request message is not transmitted, various embodiments of the process 400 may perform a transmission of the delay request message (block 440).

However, when the delay request message is transmitted, the process 400 can record a third timestamp (block 450). The third timestamp may indicate the time when the delay request message was transmitted by the second network device. In more embodiments, the third timestamp may be recorded based on a local time maintained by a communication port of the second network device that transmitted the delay request message. The communication port that received the sync message can be different from the communication port that transmitted the delay request message.

In additional embodiments, the process 400 may determine if a delay response message is received (block 455). The delay response message may be transmitted by the first network device in response to receiving the delay request message. When the delay response message is not received, various embodiments of the process 400 may continue to wait to receive the delay response message (block 455).

However, when the delay response message is received, the process 400 can retrieve a fourth timestamp from the delay response message (block 460). The fourth timestamp may indicate the time when the delay response message was transmitted by the first network device. In more embodiments, the fourth timestamp may be appended to the delay response message based on a local time maintained by a communication port of the first network device that transmitted the delay response message. The communication port that transmitted the sync message can be different from the communication port that transmitted the delay response message.

In additional embodiments, the process 400 may determine a time offset and a time delay between the first network device and the second network device (470). The time offset and the time delay may be determined based on the first through fourth timestamps. In further embodiments, the offset may represent a time difference between the clocks of the first network device and the second network device. The offset may indicate how much the clock of the second network device is either ahead of or behind the clock of the first network device. In still more embodiments, the delay may refer to the time taken for a message to travel from the first network device to the second network device, or vice versa.

In still more embodiments, the process 400 may perform synchronization with the first network device (480). The time offset and the time delay values may be utilized to synchronize the clock of the second network device with the clock of the first network device. In still further embodiments, accurate synchronization can be achieved if all communication ports of the first network device are synchronized with its system clock and all communication ports of the second network device are synchronized with its system clock accurately.

Although a specific embodiment for time synchronization between the first network device and the second network device suitable for carrying out the various steps, processes, methods, and operations described herein is discussed with respect to FIG. 4, any of a variety of systems and/or processes may be utilized in accordance with embodiments of the disclosure. For example, the second network device may initiate synchronization with the first network device after the communication ports of the second network device are accurately synchronized with its reference timer. The elements depicted in FIG. 4 may also be interchangeable with other elements of FIGS. 1-3B and 5-7 as required to realize a particularly desired embodiment.

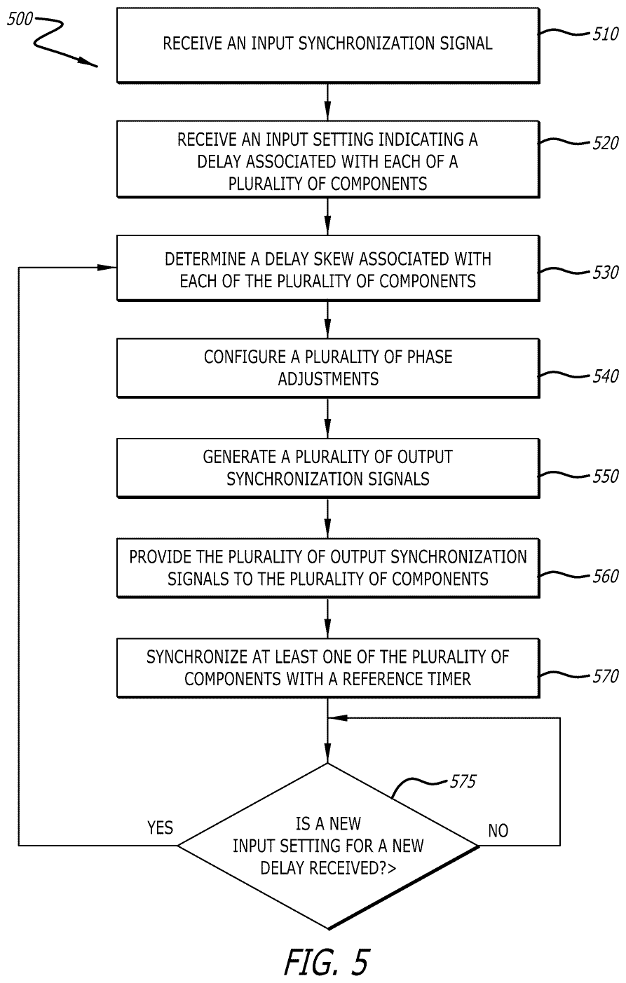

Referring to FIG. 5, a flowchart showing a process 500 for synchronizing components of a network device using phase-aligned synchronization signals in accordance with various embodiments of the disclosure is shown. In many embodiments, the process 500 may receive an input synchronization signal (block 510). For example, the input synchronization signal can be a pulse-per-second signal. In a number of embodiments, the input synchronization signal can be received from a clock generator in the network device via a serial peripheral interface. In a variety of embodiments, the input synchronization signal can be received from an external clock generator. The input synchronization signal may provide a reference point for maintaining accurate timekeeping.

In some embodiments, the process 500 may receive an input setting indicating a delay associated with each of a plurality of components (block 520). In more embodiments, the plurality of components may include a plurality of communication ports of the network device. In additional embodiments, the delay associated with a component can include an internal delay and an external propagation delay associated with the component. Further, the plurality of components may exhibit different delays, for example, due to difference in a trace propagation delay, a package delay, a buffer delay, a flip-flop delay, or the like.

In further embodiments, the process 500 may determine a delay skew associated with each of the plurality of components (block 530). The delay skew associated with each of the plurality of components may be determined based on the input setting. Delay skew associated with a component may indicate a difference between the delay associated with the component and a reference delay. In still more embodiments, one of the delay values can be selected as the reference for determining the delay skew associated with each of the plurality of components.

In still further embodiments, the process 500 may configure a plurality of phase adjustments (block 540). The plurality of phase adjustments can be configured based on the delay skew associated with each of the plurality of components. For example, if the delay skew associated with a component is less than 8 nanoseconds (ns), the phase adjustment may be configured as zero; however, if the delay skew associated with a component is greater than or equal to 8 ns, a phase adjustment equivalent to one clock cycle may be applied. In other words, the plurality of phase adjustments are configured to compensate for the delay skew associated with each of the plurality of components.

In still additional embodiments, the process 500 may generate a plurality of output synchronization signals (block 550). In some more embodiments, the plurality of output synchronization signals may be generated, for example, one for each component, by applying the plurality of phase adjustments to the input synchronization signal. By applying a phase adjustment to the input synchronization signal for each of the plurality of components, the difference in the delays of the plurality of components may be compensated. In other words, the plurality of output synchronization signals may be generated in response to the configuration of the plurality of phase adjustments.

In certain embodiments, the process 500 may provide the plurality of output synchronization signals to the plurality of components (block 560). In yet more embodiments, the plurality of output synchronization signals may be provided to local time-of-day (ToD) timers of the plurality of components. Further, the plurality of components, for example, their ToD timers may receive the plurality of output synchronization signals in a phase aligned manner.

In still yet more embodiments, the process 500 may synchronize at least one of the plurality of components with a reference timer (block 570). In many further embodiments, the local ToD timers of the plurality of components may synchronize with a system ToD timer based on the plurality of output synchronization signals that are phase aligned. Thus, improving an overall synchronization accuracy of a precision time synchronization protocol, for example, Precision Time Protocol (PTP) IEEE 1588 protocol, used by the network device.

In many additional embodiments, the process 500 may determine if a new input setting for a new delay is received (block 575). The new input setting may be indicative of delay changes or residual delay skews associated with one or more components of the network device after previous synchronization. The delay changes can occur due to component aging, component replacement, or the like. In numerous embodiments, if the delay changes are not accommodated, accuracy of time synchronization may reduce.

When the new input setting is not received, various embodiments of the process 500 may continue to monitor the delay changes (block 575). However, when the new input setting is received, various embodiments of the process 500 may determine a new delay skew associated with each of the plurality of components (block 530). The delay changes associated with one or more of the plurality of components may be accommodated by reconfiguring corresponding phase adjustments.

Although a specific embodiment for synchronizing internal components of a network device suitable for carrying out the various steps, processes, methods, and operations described herein is discussed with respect to FIG. 5, any of a variety of systems and/or processes may be utilized in accordance with embodiments of the disclosure. For example, the network device may synchronize various communication ports in a physical layer of the network device using the phase-aligned output synchronization signals and improve the accuracy of PTP as defined by IEEE 1588 protocol. The elements depicted in FIG. 5 may also be interchangeable with other elements of FIGS. 1-4, 6, and 7 as required to realize a particularly desired embodiment.

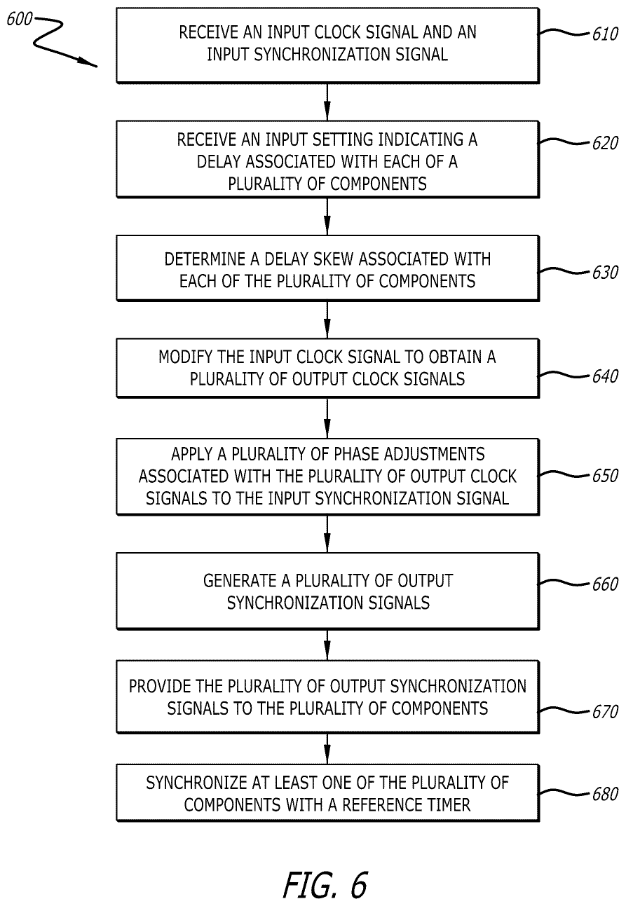

Referring to FIG. 6, a flowchart showing a process 600 for synchronizing components of a network device using phase-aligned synchronization signals in accordance with various embodiments of the disclosure is shown. In many embodiments, the process 600 may receive an input clock signal and an input synchronization signal (block 610). In an example, the input synchronization signal can be a pulse-per-second signal and the input clock signal can be a 125 MHz square pulse. In a number of embodiments, the input clock signal and the input synchronization signal can be received from a clock generator in the network device via a serial peripheral interface. In a variety of embodiments, the input clock signal and the input synchronization signal can be received from an external clock generator.

In some embodiments, the process 600 may receive an input setting indicating a delay associated with each of a plurality of components (block 620). In more embodiments, the delay associated with a component can include an internal delay and an external propagation delay associated with the component. Further, the plurality of components may exhibit different delays, for example, due to difference in trace propagation delay, a package delay, a buffer delay, a flip-flop delay, or the like.

In additional embodiments, the process 600 may determine a delay skew associated with each of the plurality of components (block 630). The delay skew associated with each of the plurality of components may be determined based on the input setting. Delay skew associated with a component may indicate a difference between the delay associated with the component and a reference. In still more embodiments, one of the delay values can be selected as the reference for the determination of the delay skew associated with each of the plurality of components.

In further embodiments, the process 600 may modify the input clock signal to obtain a plurality of output clock signals (block 640). The input clock signal may be modified based on individual delay skew associated with each component and an output clock signals may be obtained for each component. In still more embodiments, each output clock signal may be associated with a phase adjustment corresponding to the delay skew. For example, a phase adjustment of one clock cycle may be associated with an output clock signal for a delay skew of 8 nanoseconds. Likewise, a phase adjustment of two clock cycles may be associated with an output clock signal for a delay skew of 16 nanoseconds.

In still further embodiments, the process 600 may apply a plurality of phase adjustments associated with the plurality of output clock signals to the input synchronization signal (block 650). For example, an individual phase adjustment may be applied to the input synchronization signal for each of the plurality of components. Each phase adjustment may phase shift the input synchronization signal so as to compensate for the corresponding delay skew.

In still additional embodiments, the process 600 may generate a plurality of output synchronization signals (block 660). Each output synchronization signal may be a mirror of the input synchronization signal with the phase shift associated with the applied phase adjustment. By applying the individual phase adjustments to the input synchronization signal for each component, the difference in the delays of the plurality of components may be compensated.

In some more embodiments, the process 600 may provide the plurality of output synchronization signals to the plurality of components (block 670). The plurality of components may receive the plurality of output synchronization signals which are phase aligned with each other. In certain embodiments, local time-of-day (ToD) timers of the plurality of components may receive the plurality of output synchronization signals in a phase aligned manner.

In yet more embodiments, the process 600 may synchronize at least one of the plurality of components with a reference timer (block 680). In still yet more embodiments, the local ToD timers of the plurality of components may synchronize with a system ToD timer based on the plurality of output synchronization signals that are phase aligned. Thus, improving an overall synchronization accuracy of a precision time synchronization protocol, for example, PTP IEEE 1588 protocol, used by the network device.

Although a specific embodiment for synchronizing internal components of a network device suitable for carrying out the various steps, processes, methods, and operations described herein is discussed with respect to FIG. 6, any of a variety of systems and/or processes may be utilized in accordance with embodiments of the disclosure. For example, the network device may monitor changes in the delays or residual delay skews associated with the plurality of components and reconfigure the plurality of phase adjustments to accommodate the delay changes. The elements depicted in FIG. 6 may also be interchangeable with other elements of FIGS. 1-5 and 7 as required to realize a particularly desired embodiment.

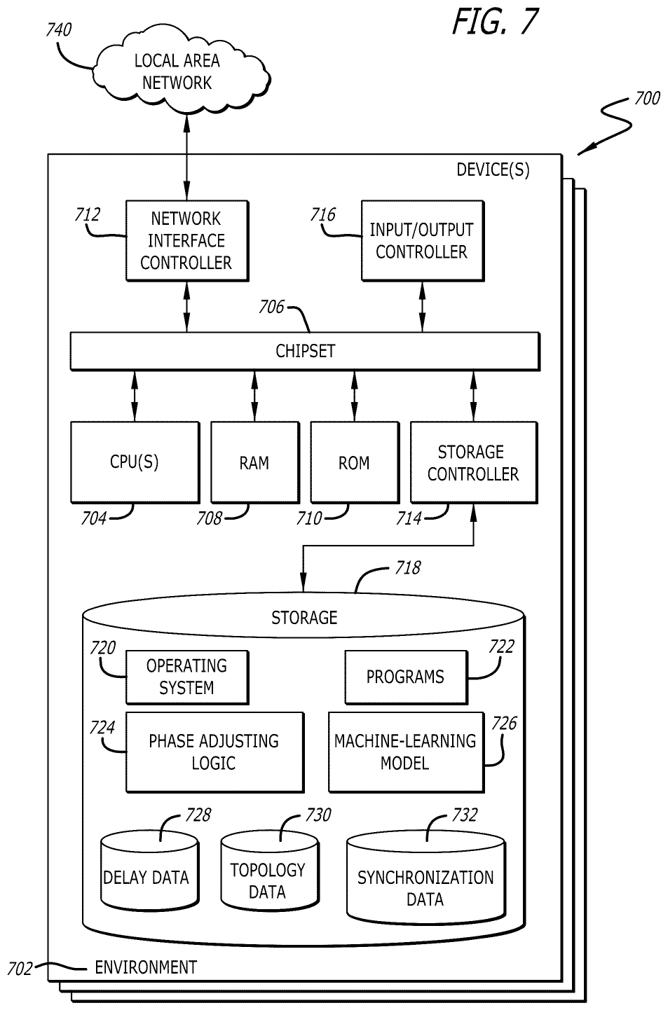

Referring to FIG. 7, a conceptual block diagram for one or more devices 700 capable of executing components and logic for implementing the functionality and embodiments described above is shown. The embodiment of the conceptual block diagram depicted in FIG. 7 can illustrate a conventional server computer, workstation, desktop computer, laptop, tablet, network appliance, e-reader, smartphone, or other computing device, and can be utilized to execute any of the application and/or logic components presented herein. The device 700 may, in some examples, correspond to physical devices or to virtual resources described herein.

In many embodiments, the device 700 may include an environment 702 such as a baseboard or “motherboard,” in physical embodiments that can be configured as a printed circuit board with a multitude of components or devices connected by way of a system bus or other electrical communication paths. Conceptually, in virtualized embodiments, the environment 702 may be a virtual environment that encompasses and executes the remaining components and resources of the device 700. In more embodiments, one or more processors 704, such as, but not limited to, central processing units (“CPUs”) can be configured to operate in conjunction with a chipset 706. The processor(s) 704 can be standard programmable CPUs that perform arithmetic and logical operations necessary for the operation of the device 700.

In additional embodiments, the processor(s) 704 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 706 may provide an interface between the processor(s) 704 and the remainder of the components and devices within the environment 702. The chipset 706 can provide an interface to a random-access memory (“RAM”) 708, which can be used as the main memory in the device 700 in some embodiments. The chipset 706 can further be configured to provide an interface to a computer-readable storage medium such as a read-only memory (“ROM”) 710 or non-volatile RAM (“NVRAM”) for storing basic routines that can help with various tasks such as, but not limited to, starting up the device 700 and/or transferring information between the various components and devices. The ROM 710 or NVRAM can also store other application components necessary for the operation of the device 700 in accordance with various embodiments described herein.

Different embodiments of the device 700 can be configured to operate in a networked environment using logical connections to remote computing devices and computer systems through a network, such as the network 740. The chipset 706 can include functionality for providing network connectivity through a network interface card (“NIC”) 712, which may comprise a gigabit Ethernet adapter or similar component. The NIC 712 can be capable of connecting the device 700 to other devices over the network 740. It is contemplated that multiple NICs 712 may be present in the device 700, connecting the device to other types of networks and remote systems.

In further embodiments, the device 700 can be connected to a storage 718 that provides non-volatile storage for data accessible by the device 700. The storage 718 can, for example, store an operating system 720, applications 722, and data 728, 730, 732, which are described in greater detail below. The storage 718 can be connected to the environment 702 through a storage controller 714 connected to the chipset 706. In certain embodiments, the storage 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 700 can store data within the storage 718 by transforming the physical state of the physical storage units to reflect the information being stored. The specific transformation of physical state can depend on various factors. Examples of such factors can include, but are not limited to, the technology used to implement the physical storage units, whether the storage 718 is characterized as primary or secondary storage, and the like.

For example, the device 700 can store information within the storage 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 700 can further read or access information from the storage 718 by detecting the physical states or characteristics of one or more particular locations within the physical storage units.

In addition to the storage 718 described above, the device 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 700. In some examples, the operations performed by a cloud computing network, and or any components included therein, may be supported by one or more devices similar to device 700. Stated otherwise, some or all of the operations performed by the cloud computing network, and or any components included therein, may be performed by one or more devices 700 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 718 can store an operating system 720 utilized to control the operation of the device 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 718 can store other system or application programs and data utilized by the device 700.

In various embodiment, the storage 718 or other computer-readable storage media is encoded with computer-executable instructions which, when loaded into the device 700, may transform it from a general-purpose computing system into a special-purpose computer capable of implementing the embodiments described herein. These computer-executable instructions may be stored as application 722 and transform the device 700 by specifying how the processor(s) 704 can transition between states, as described above. In some embodiments, the device 700 has access to computer-readable storage media storing computer-executable instructions which, when executed by the device 700, perform the various processes described above with regard to FIGS. 1-9. In more embodiments, the device 700 can also include computer-readable storage media having instructions stored thereupon for performing any of the other computer-implemented operations described herein.

In still further embodiments, the device 700 can also include one or more input/output controllers 716 for receiving and processing input from a number of input devices, such as a keyboard, a mouse, a touchpad, a touch screen, an electronic stylus, or other type of input device. Similarly, an input/output controller 716 can be configured to provide output to a display, such as a computer monitor, a flat panel display, a digital projector, a printer, or other type of output device. Those skilled in the art will recognize that the device 700 might not include all of the components shown in FIG. 7, and can include other components that are not explicitly shown in FIG. 7, or might utilize an architecture completely different than that shown in FIG. 7.

As described above, the device 700 may support a virtualization layer, such as one or more virtual resources executing on the device 700. In some examples, the virtualization layer may be supported by a hypervisor that provides one or more virtual machines running on the device 700 to perform functions described herein. The virtualization layer may generally support a virtual resource that performs at least a portion of the techniques described herein.

In many embodiments, the device 700 can include a phase adjusting logic 724 that can be configured to perform one or more of the various steps, processes, operations, and/or other methods that are described above. Often, the phase adjusting logic 724 can be a set of instructions stored within a non-volatile memory that, when executed by the processor(s)/controller(s) 704 can carry out these steps, etc. In some embodiments, the phase adjusting logic 724 may be a client application that resides on a network-connected device, such as, but not limited to, a server, switch, personal or mobile computing device, an access point (AP). In certain embodiments, the phase adjusting logic 724 can enable time synchronization of a plurality of components of the device 700 using phase-aligned output synchronization signals. Examples of the components that can be time synchronized using phase-aligned output synchronization signals may include, but are not limited to, communication ports, security modules, antenna arrays, radio frequency components, power management components, or the like.

In several embodiments, the phase adjusting logic 724 can enable the device 700 to generate a plurality of output synchronization signals (e.g., a plurality of pulse-per-second signals) that are phase aligned with each other. In more embodiments, the plurality of output synchronization signals can be phase aligned with each other with a margin of error of less than or equal to a preset value. The preset value may correspond to a maximum timing error associated with one or more functional applications of the device 700. For example, if the device 700 is a PTP enabled device and implements a specific application, the preset value can be determined based on a class or level of accuracy defined in the PTP for those applications. In numerous embodiments, the phase adjusting logic 724 can perform one or more operations such as modifying an input clock signal as per delay skews associated with each of the components and phase shifting an input synchronization signal by utilizing the modified clock signals.

In a number of embodiments, the storage 718 can include delay data 728. In some embodiments, delay data 728 can include information on, for example, a trace propagation delay, a package delay, a buffer delay, a flip-flop delay, or any other external/internal delay associated with the plurality of components of the device 700. In many embodiments, the delay data 728 may be utilized to determine a delay skew associated with each component. In numerous embodiments, the delay data 728 may be utilized to time synchronize the plurality of components with a margin of error of less than or equal to the preset value.

In various embodiments, the storage 718 can include topology data 730. The topology data 730 can comprise information detailing the physical or logical arrangement of network devices and their interconnections. This data can provide insights into the structure of the network, including the relationships between routers, switches, servers, and other components. Topology data 730 can describe the actual layout of devices, such as their placement in a building or across multiple locations, while logical topology data may focus on the communication paths and relationships between devices (e.g., master-slave relationship in PTP) regardless of their physical location. Understanding network topology is crucial for troubleshooting, optimizing performance, and planning for scalability. It can enable network administrators to identify potential points of failure, ensure efficient data flow, and make informed decisions about network expansion or reconfiguration. Advanced tools and technologies are often employed to visualize and analyze topology data 730, aiding in the effective management and maintenance of complex network infrastructures.

In still more embodiments, the storage 718 can include synchronization data 732. Synchronization data 732 may include a plurality of phase adjustments configured for generating phase-aligned output synchronization signals for the plurality of components of the device 700. Each phase adjustment may be associated with a different component and may be configured to compensate for a delay skew (e.g., difference between the delay of the component and a reference value) associated with the component. Thus, the plurality of phase adjustments when applied to the input synchronization signal (e.g., a pulse-per-second signal) can generate the plurality of output synchronization signals for the plurality of components. Since the plurality of output synchronization signals are already compensated for an individual delay skew associated with each of the plurality of components, the plurality of components may receive the plurality of output synchronization signals in a phase aligned manner.

Finally, in many embodiments, data may be processed into a format usable by a machine-learning model 726 (e.g., feature vectors), and or other pre-processing techniques. The machine-learning (“ML”) model 726 may be any type of ML model, such as supervised models, reinforcement models, and/or unsupervised models. The ML model 726 may include one or more of linear regression models, logistic regression models, decision trees, Naïve Bayes models, neural networks, k-means cluster models, random forest models, and/or other types of ML models 726. The ML model 726 may be configured to learn a relationship between a delay associated with a component and various operational parameters of the component and generate prediction for a phase adjustment that can compensate for the delay.

The ML model(s) 726 can be configured to generate inferences to make predictions or draw conclusions from data. An inference can be considered the output of a process of applying a model to new data. This can occur by learning from infrastructure data, sustainability data, and/or health data and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 726 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a plurality of components;
a processor;
a network interface controller configured to provide access to a network; and
a memory communicatively coupled to the processor, wherein the memory comprises a phase adjusting logic that is configured to:
receive an input synchronization signal;
generate a plurality of output synchronization signals by applying a plurality of phase adjustments to the input synchronization signal; and
provide a corresponding output synchronization signal of the plurality of output synchronization signals to each of the plurality of components.

2. The device of claim 1, wherein the input synchronization signal is a pulse-per-second signal.

3. The device of claim 1, wherein each of the plurality of output synchronization signals is associated with a different phase adjustment of the plurality of phase adjustments.

4. The device of claim 1, wherein to generate the plurality of output synchronization signals, the phase adjusting logic is further configured to:
receive an input setting indicative of a delay associated with each of the plurality of components;
determine a delay skew associated with each component of the plurality of components based on the input setting; and
configure the plurality of phase adjustments based on the delay skew associated with each component of the plurality of components, wherein the plurality of output synchronization signals are generated in response to the configuration of the plurality of phase adjustments.

5. The device of claim 4, wherein the delay comprises at least one of a trace propagation delay, a package delay, a buffer delay, or a flip-flop delay.

6. The device of claim 4, wherein the plurality of phase adjustments are reconfigurable to accommodate one or more delay changes associated with one or more of the plurality of components.

7. The device of claim 1, wherein the memory further comprises a reference timer configured to provide a reference time.

8. The device of claim 7, wherein at least one of the plurality of components is configured to synchronize with the reference timer based on the corresponding output synchronization signal.

9. The device of claim 1, wherein the plurality of output synchronization signals are phase aligned with each other.

10. The device of claim 1, wherein the plurality of output synchronization signals are phase aligned with each other with a margin of error of less than or equal to a preset value.

11. The device of claim 10, wherein the preset value corresponds to a maximum timing error associated with one or more functional applications of the device.

12. The device of claim 1, wherein the plurality of components comprise at least one communication port.

13. A device, comprising:
a plurality of components;
a processor;
a network interface controller configured to provide access to a network;
a memory communicatively coupled to the processor; and
a phase adjusting logic is configured to:
receive an input clock signal and an input synchronization signal;
modify the input clock signal based on a delay skew associated with each of the plurality of components to obtain a plurality of output clock signals;
generate a plurality of output synchronization signals based on the input synchronization signal and the plurality of output clock signals; and
provide the plurality of output synchronization signals to the plurality of components.

14. The device of claim 13, wherein the plurality of output clock signals are associated with a plurality of phase adjustments.

15. The device of claim 14, wherein to generate the plurality of output synchronization signals, the phase adjusting logic is further configured to apply the plurality of phase adjustments associated with the plurality of output clock signals to the input synchronization signal.

16. The device of claim 15, wherein each of the plurality of output synchronization signals is a mirror of the input synchronization signal with a phase shift associated with an output clock signal of the plurality of output clock signals.

17. The device of claim 13, further comprising:
one of a phase locked loop (PLL) or a mixed-mode clock manager (MMCM); and
a plurality of buffers coupled to the one of the phase locked loop (PLL) or the mixed-mode clock manager (MMCM).

18. The device of claim 17, wherein the phase adjusting logic is implemented based on the plurality of buffers and one of the PLL or the MMCM.

19. A method of time synchronization, comprising:
receiving an input synchronization signal;
generating a plurality of output synchronization signals by applying a plurality of phase adjustments on the input synchronization signal; and
synchronizing a plurality of components in a device with a reference timer based on the plurality of output synchronization signals.

20. The method of claim 19, further comprising reconfiguring one or more of the plurality of phase adjustments based one or more delay changes associated with one or more of the plurality of components.
